(19) United States
(12) Patent Application Publication
(10) Pub. No.: US 2024/0322295 A1
(43) Pub. Date: Sep. 26, 2024

(54) BATTERY CASE AND MANUFACTURING METHOD THEREOF

(71) Applicant: HONDA MOTOR CO., LTD., Tokyo (JP)

(72) Inventors: Akio YOKOYAMA, Tokyo (JP); Goichi KATAYAMA, Tokyo (JP); Toshihide SUNADA, Tokyo (JP)

(73) Assignee: HONDA MOTOR CO., LTD., Tokyo (JP)

(21) Appl. No.: 18/591,908

(22) Filed: Feb. 29, 2024

(30) Foreign Application Priority Data
Mar. 24, 2023 (JP) 2023-048489

(51) Int. Cl. H01M 10/6556; B21D 51/16; H01M 10/613; H01M 10/6567

(52) U.S. Cl. CPC H01M 10/6556; B21D 51/16; H01M 10/613; H01M 10/6567

(57) ABSTRACT

A battery case includes a refrigerant flow path formed by welding case members at mating surfaces and by covering them with a cover plate. Each of the case members includes a first convex portion extending flatly along a flow direction, a second convex portion extending flatly in a direction orthogonal to the flow direction at a position of the mating surfaces, and a concave portion. The first and second convex portion intersect with each other flatly without a step. The cover plate includes a concave portion and a convex portion extending flatly without a step along the flow direction. The refrigerant flow path is formed by welding the first convex portions and the convex portion and includes a first space between the concave portions of the case members and of the cover plate, and a second space between the second convex portions and the concave portion of the cover plate.

This application is based upon and claims the benefit of priority from prior Japanese patent application No. 2023-48489, filed on Mar. 24, 2023, the entire contents of which are incorporated herein by reference.

### TECHNICAL FIELD

The present invention relates to a battery case and a manufacturing method thereof.

### BACKGROUND ART

In recent years, efforts to implement a low-carbon society or a decarbonized society become active, and research and development of electrification technique are conducted to reduce CO2 emission and improve energy efficiency in vehicles.

Batteries play an important role in the electrification technique. Since a battery is a heat generation component, it is necessary to perform temperature management as appropriate. For example, a battery pack with a battery case having a double-bottom structure in which a heat sink is formed between a lower panel and a share panel is disclosed in JP2022-155479A.

### SUMMARY

In JP2022-155479A, the heat sink provided as a separate member between the lower panel and the share panel causes an increase in cost and weight. Therefore, it is considered that a water jacket is formed between the two plate members, but in this case, since a refrigerant flow path is formed between the two plate members, highly accurate welding quality is required. Further, in recent years, it is also considered to manufacture a battery case by dividing the battery case, and there is also room for considering welding the case members to each other.

Aspects of the present disclosure relates to providing a battery case having stable welding quality and a manufacturing method thereof.

According to an aspect of the present disclosure, there is provided a battery case including:
a refrigerant flow path formed by welding case members on which irregularities are formed to each other at mating surfaces facing each other and by covering the irregularities with a cover plate, in which
the refrigerant flow path is formed in a direction orthogonal to a plane including the mating surfaces at a position of the mating surfaces,
each of the case members includes
   a first convex portion that extends continuously and flatly without a step along a flow direction of the refrigerant flow path,
   a second convex portion that extends continuously and flatly without a step in a direction orthogonal to the flow direction at a position of the mating surfaces, and
   a concave portion,
the first convex portion and the second convex portion intersect with each other flatly without a step at an intersecting position,
the cover plate includes a concave portion and a convex portion extending flatly without a step along the flow direction, and
the refrigerant flow path is formed by welding the first convex portions and the convex portion of the cover plate, and includes
   a first space formed between the concave portions of the case members and the concave portion of the cover plate, and
   a second space formed between the second convex portions and the concave portion of the cover plate.

According to another aspect of the present disclosure, there is provided a method for manufacturing a battery case, the method including:
pressing a metal plate material to form a cover plate on which an irregularity serving as a flow path is provided;
molding case members on which an irregularity is formed;
welding the case members to each other at mating surfaces to form a case; and
covering the case with the cover plate on which the irregularity is formed, and welding a convex portion of the case members and a convex portion of the cover plate to each other to form a refrigerant flow path, in which,
in molding each of the case members by die-casting aluminum alloy,
   a portion to be welded to the cover plate and a portion along the mating surface of the case member are formed to be thick portions, and
   molding is performed such that heights of the thick portions are same over an entire surface of the case member.

According to aspects of the present disclosure, stable welding quality may be implemented in a battery case including a refrigerant flow path.

### BRIEF DESCRIPTION OF DRAWINGS

Exemplary embodiment(s) of the present invention will be described in detail based on the following figures, wherein:

FIG. 1A shows, among assembly steps of a battery case 1, a case member molding step of forming a first case member 11 and a second case member 12;

FIG. 1B shows, among the assembly steps of a battery case 1, a case welding step of welding the first case member 11 and the second case member 12 to each other at a mating surface X to form a case 10;

FIG. 1C shows, among the assembly steps of a battery case 1, a cover plate welding step of covering the case 10 with a cover plate 20 to form a refrigerant flow path;

FIG. 2 is an enlarged perspective view of a region A in FIG. 1B;

FIG. 3 is an exploded perspective view of the battery case 1;

FIG. 4 is a bottom view of the battery case 1;

FIG. 5 is a cross-sectional view taken along a line B-B in FIG. 4;

FIG. 6 is a view of the case welding step at the mating surface X when viewed from a direction of an arrow P1-P1 in FIG. 2;

FIG. 7 is a view of the case welding step at the mating surface X when viewed from a direction of an arrow P2 in FIG. 2;

FIG. 8 is a view of the cover plate welding step of welding the cover plate 20 and the first case member 11 as well as the second case member 12 to each other when viewed from a direction of the arrow P1-P1 in FIG. 2; and

FIG. 9 is a view of the cover plate welding step of welding the cover plate 20 and the first case member 11 as well as the second case member 12 to each other when viewed from a cross section taken along a line B-B in FIG. 8.

### DESCRIPTION OF EMBODIMENTS

Hereinafter, a battery case and a manufacturing method thereof according to the present disclosure will be described with reference to the drawings.

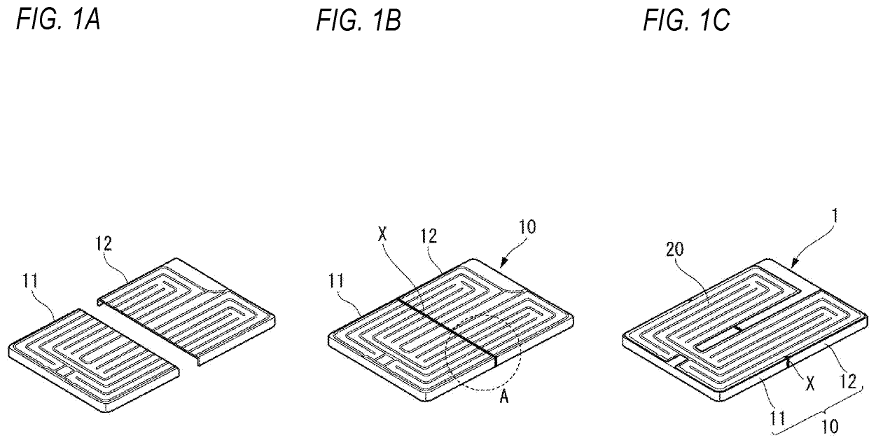

As shown in FIGS. 1A, 1B, and 1C, a battery case 1 according to an embodiment of the present disclosure is formed by welding a first case member 11 and a second case member 12, which are two case members, to each other at a facing mating surface X, and covering irregularities of the first case member 11 and the second case member 12 with a cover plate 20. The battery case 1 is covered by a cover plate (not shown) with a battery housed therein, and is fixed under a floor of an electric vehicle.

As shown in FIG. 1A, each of the first case member 11 and the second case member 12 is a case member on which irregularities are formed. The first case member 11 and the second case member 12 are, for example, die-cast products made of aluminum alloy. In the present embodiment, the first case member 11 and the second case member 12 have a substantially rectangular shape in a plan view, and three sides among four sides of a peripheral edge are bent.

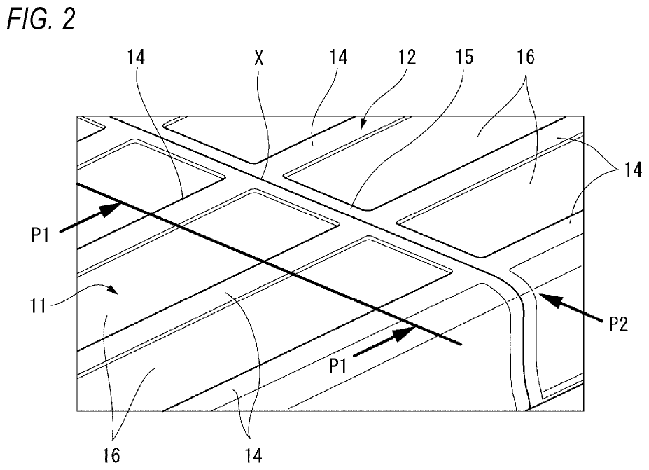

As shown in FIGS. 1B and 2, the first case member 11 and the second case member 12 are welded at the mating surface X, whereby an integrated case 10 is formed. Among various welding methods, particularly, friction stir welding (FSW) is preferably used.

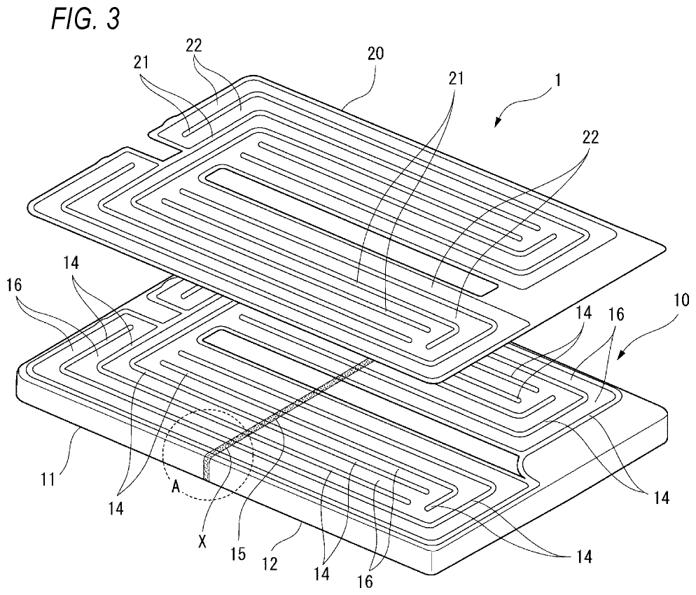

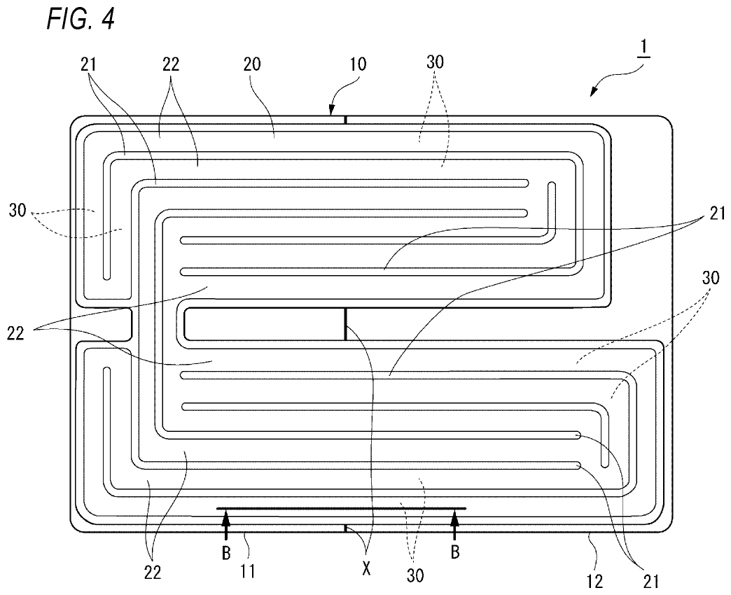

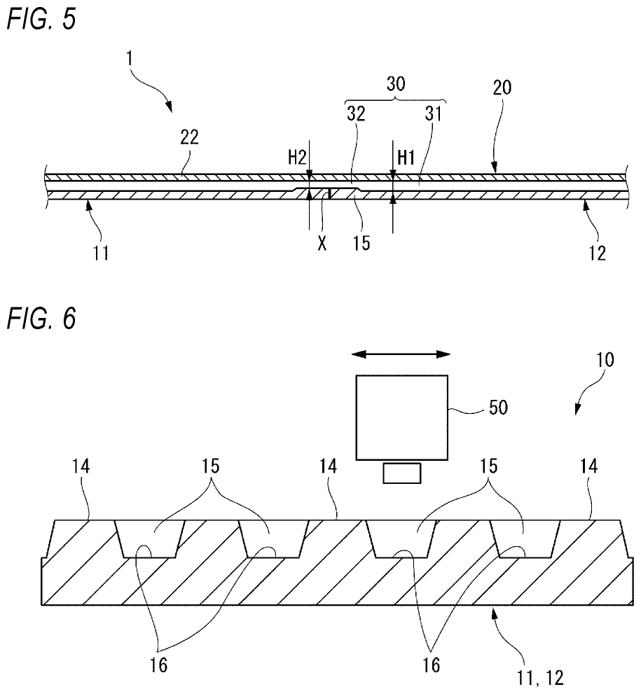

As shown in FIGS. 1C and 3, the battery case 1 is completed by performing fixing so as to cover irregularities of the case 10 with the cover plate 20. The cover plate 20 is a plate-shaped member on which irregularities are formed, and is, for example, a press-molded product made of a plate material. As shown in FIGS. 4 and 5, in the battery case 1, a refrigerant flow path 30 is formed between the case 10 and the cover plate 20. Accordingly, the battery housed in the battery case 1 is cooled and/or warmed by a refrigerant that flows through the refrigerant flow path 30, so that a temperature of the battery may be adjusted.

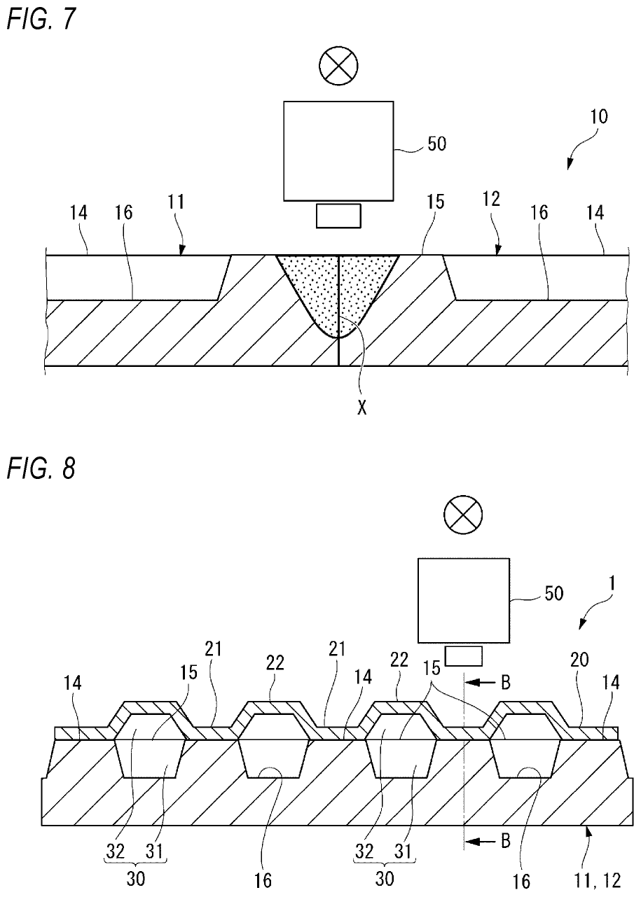

As shown in FIG. 3, each of the first case member 11 and the second case member 12 includes a first convex portion 14, a second convex portion 15, and a concave portion 16. The first convex portion 14 is formed so as to extend continuously and flatly without a step along a flow direction of the refrigerant flow path 30 shown in FIGS. 4 and 5. Referring also to FIGS. 6 and 7, the second convex portion 15 is formed at a position of the mating surface X so as to extend continuously and flatly without a step in a direction orthogonal to the flow direction. The first convex portion 14 and the second convex portion 15 intersect with each other flatly without a step at an intersecting position.

The concave portion 16 is a concave portion formed between the adjacent first convex portions 14. It can also be said that the first convex portion 14 and the second convex portion protrude in a height direction of the first case member 11 and the second case member 12 from the concave portion 16.

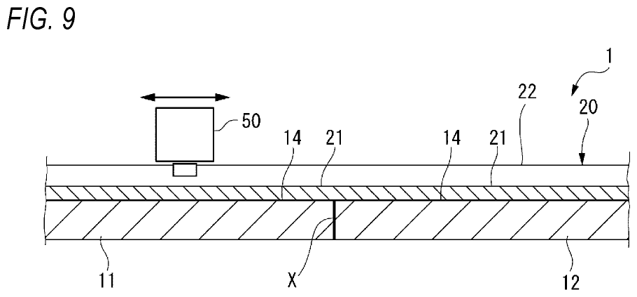

As shown in FIG. 3, the cover plate 20 includes a convex portion 21 and a concave portion 22 that extend flatly without a step along the flow direction of the refrigerant flow path shown in FIGS. 4 and 5. Referring also to FIGS. 8 and 9, the convex portion 21 protrudes toward the case 10, and the concave portion 22 is recessed in a direction away from the case 10. That is, in the present specification, the convex portion 21 and the concave portion 22 are defined by protrusion or concavity with respect to a direction on a case 10 side from the cover plate 20.

As shown in FIGS. 4 and 5, the refrigerant flow path 30 is formed in a direction orthogonal to a plane including the mating surface X at the position of the mating surface X.

As shown in FIGS. 8 and 9, the refrigerant flow path 30 is formed by welding the first convex portions 14 of the first case member 11 and the second case member 12 to the convex portion 21 of the cover plate 20. The friction stir welding is also preferably used for this welding. With such a welded structure, as shown in FIG. 5, the refrigerant flow path 30 includes two types of spaces including a first space 31 and a second space 32.

The first space 31 is a space formed between the concave portions 16 of the first case member 11 and the second case member 12 and the concave portion 22 of the cover plate 20. On the other hand, the second space 32 is a space formed between the second convex portions of the first case member 11 and the second case member 12 and the concave portion 22 of the cover plate 20.

That is, regarding the first case member 11 and the second case member 12, the concave portions 16 and the second convex portions 15 serve to define the refrigerant flow path 30. The concave portions 16 serve to define the first space 31, and the second convex portions serve to define the second space 32.

On the other hand, regarding the cover plate 20, the concave portion 22 serves to define both the first space 31 and the second space 32.

According to the configuration described above, since the second convex portions 15 extend continuously and flatly without a step at the mating surface X, stable welding quality may be implemented even for product variations in the first case member 11 and the second case member 12. Further, since the intersecting portions between the first convex portions 14 and the second convex portions 15 extend continuously and flatly without a step, stable welding quality may be implemented even when the convex portion 21 of the cover plate 20 is welded.

As described above, the cover plate 20 is, for example, a press-molded product made of a plate material. The first case member 11 and the second case member 12 are, for example, die-cast products made of aluminum alloy. Further, in the first case member 11 and the second case member 12, the second convex portion 15 is formed to be thicker than the concave portion 16. Therefore, a sufficient welding depth is ensured during the friction stir welding.

In the refrigerant flow path 30, the second space 32 is formed between the second convex portions 15 of the first case member 11 and the second case member 12 and the concave portion 22 of the cover plate 20. Therefore, by adjusting an amount of irregularities of the second convex portions 15, a flow path cross section at the position of the mating surface X of the first case member 11 and the second case member 12 may be adjusted. Further, a plate thickness of the first case member 11 and the second case member 12 at the concave portions 16 excluding the first convex portions 14 and the second convex portions 15 is reduced while stabilizing the welding quality by thickening the second convex portions 15, whereby a weight of the battery pack may be reduced.

As shown in FIG. 5, in the refrigerant flow path 30, a height H2 of the second space 32 is smaller than a height H1 of the first space 31. Accordingly, a step is formed at a boundary between the first space 31 and the second space 32 in the refrigerant flow path 30. Accordingly, turbulence is generated in the refrigerant flow path 30, cooling efficiency is increased more than that in a state where only a surface layer is warmed up, and a flow rate is increased at the step, so that heat dissipation is improved. Accordingly, cooling capacity may be improved.

Next, a method for manufacturing the battery case 1 will be described. It should be noted that in FIGS. 6 to 9, the irregularities are shown in an exaggerated manner for ease of understanding.

First, a metal plate material is pressed to form the cover plate 20 provided with the irregularities serving as the flow path (cover plate formation step). In addition to the formation of the cover plate 20, as shown in FIG. 1A, the first case member 11 and the second case member 12 on which irregularities are formed are formed (case member molding step).

Here, in the case member molding step shown in FIG. 1A, the portions to be welded to the cover plate 20, that is, the first convex portions 14 and the portions of the first case member 11 and the second case member 12 along the mating surface X, that is, the second convex portions 15 are formed to be thick by die-casting the aluminum alloy that is raw materials of the first case member 11 and the second case member 12.

As shown in FIG. 2, the first case member 11 and the second case member 12 are molded such that a height of a thick portion including both the first convex portions 14 that are the portions to be welded to the cover plate 20 and the second convex portions 15 that are the portions along the mating surface X is the same across entire surfaces of the first case member 11 and the second case member 12.

Since the flat welding surface is obtained according to such molding, stable welding quality may be implemented in a subsequent case welding step. Further, stable welding quality may be implemented even for variations in a combination of the first case member 11 and the second case member 12 molded by casting molds. Furthermore, a plate thickness of the first case member 11 and the second case member 12 at the concave portions 16 excluding the first convex portions 14 and the second convex portions 15 is reduced, whereby the weight of the battery pack may be reduced.

Next, as shown in FIG. 1B, the first case member 11 and the second case member 12 are welded at the mating surface X to form the case 10 (case welding step).

Specifically, As shown in FIGS. 6 and 7, the second convex portions 15 formed to be thick along the mating surface X are welded by the friction stir welding. The friction stir welding is a welding method in which materials softened by frictional heat are stirred and welded. In the present example, a friction stir welding tool 50 moves (moves in a left-right direction in FIG. 6 and in a direction perpendicular to a paper surface in FIG. 7) while rotating while pressing the portions of the second convex portions 15 from above with a predetermined force. In the process, a part of the second convex portions 15 spanning both the first case member 11 and the second case member 12 (a region hatched with dots in FIG. 7) is softened by a rotational force of the friction stir welding tool 50, and respective portions of the first case member 11 and the second case member 12 are kneaded and integrated by plastic flow.

Finally, as shown in FIG. 1C, the case 10 is covered by the cover plate 20 on which the irregularities are formed, and the first convex portions 14 of the first case member 11 and the second case member 12 and the convex portion 21 of the cover plate 20 are welded to each other to form the refrigerant flow path 30 (cover plate welding step).

Specifically, as shown in FIGS. 8 and 9, welding is performed by the friction stir welding along the first convex portions 14 of the first case member 11 and the second case member 12 and the convex portion 21 of the cover plate 20. Also in FIGS. 8 and 9, the friction stir welding tool 50 moves (moves in a direction perpendicular to the paper surface in FIG. 8 and in a left-right direction in FIG. 9) while rotating while pressing the portions of the first convex portions 14 and the portion of the convex portion 21 with a predetermined force. In the process, the first convex portions 14 and the convex portion 21 are softened by the rotational force of the friction stir welding tool 50 and are kneaded and integrated by the plastic flow.

According to such welding, since only a flat portion including the first convex portions 14 and the convex portion 21 is welded, by applying the friction stir welding, an amount of heat input is smaller than that of laser welding, and therefore a distortion of a welded product may be reduced. Accordingly, it is possible to both improve the welding quality and accuracy of a product.

Although various embodiments have been described above with reference to the drawings, it is needless to say that the present disclosure is not limited to these examples. It is apparent that those skilled in the art can conceive of various modifications and changes within the scope described in the claims, and it is understood that such modifications and changes naturally fall within the technical scope of the present disclosure. Further, constituent elements in the embodiment described above may be freely combined in a scope not departing from the gist of the disclosure.

For example, the case 10 is not limited to a case made of two case members. The case may be formed by welding three or more case members.

The friction stir welding is exemplified as a preferred welding method, but the present disclosure is not limited thereto, and other welding methods such as laser welding may be used.

In the present specification, at least the following matters are described. Corresponding constituent elements and the like in the embodiments described above are shown in parentheses, but the present disclosure is not limited thereto.

(1) A battery case (battery case 1) including:
a refrigerant flow path (refrigerant flow path 30) formed by welding case members (a first case member 11, a second case member 12) on which irregularities are formed to each other at mating surfaces (mating surfaces X) facing each other and by covering the irregularities with a cover plate (cover plate 20), in which
   the refrigerant flow path is formed in a direction orthogonal to a plane including the mating surfaces at a position of the mating surfaces,
   each of the case members includes
      a first convex portion (first convex portion 14) that extends continuously and flatly without a step along a flow direction of the refrigerant flow path,
      a second convex portion (second convex portion 15) that extends continuously and flatly without a step in a direction orthogonal to the flow direction at a position of the mating surfaces, and
      a concave portion (concave portion 16),
   the first convex portion and the second convex portion intersect with each other flatly without a step at an intersecting position,
   the cover plate includes a concave portion (concave portion 22) and a convex portion (convex portion 21) extending flatly without a step along the flow direction, and
   the refrigerant flow path is formed by welding the first convex portions and the convex portion of the cover plate, and includes
      a first space (first space 31) formed between the concave portions of the case members and the concave portion of the cover plate, and
      a second space (second space 32) formed between the second convex portions and the concave portion of the cover plate.

According to (1), since the second convex portion extends continuously and flatly without a step at the mating surface, stable welding quality may be implemented even for a product variation in the case member. Further, since the intersecting portion between the first convex portion and the second convex portion extends continuously and flatly without a step, stable welding quality may be implemented even when the convex portion of the cover plate is welded.

(2) The battery case according to (1), in which
the cover plate is a press-molded product made of a plate material,
the case members are die-cast products, and
the second convex portion is formed to be thicker than the concave portion of the case members.

The second space is formed between the second convex portion of the case member and the concave portion of the cover plate in the refrigerant flow path. According to (2), by adjusting an amount of irregularities of the second convex portion, a flow path cross section at a position of the mating surface of the case member may be adjusted. Further, a plate thickness of the case members at the concave portions excluding the first convex portions and the second convex portions is reduced while stabilizing welding quality by thickening the second convex portions, whereby a weight of the battery pack may be reduced.

(3) The battery case according to (2), in which
a height of the second space is smaller than a height of the first space in the refrigerant flow path.

According to (3), a step is formed at a boundary between the first space and the second space in the refrigerant flow path. Accordingly, turbulence is generated in the refrigerant flow path, cooling efficiency is increased more than that in a state where only a surface layer is warmed up, and a flow rate is increased at the step, so that heat dissipation is improved. Accordingly, cooling capacity may be improved.

(4) A method for manufacturing a battery case, the method including:
pressing a metal plate material to form a cover plate on which an irregularity serving as a flow path is provided;
molding case members on which an irregularity is formed;
welding the case members to each other at mating surfaces to form a case; and
covering the case with the cover plate on which the irregularity is formed, and welding a convex portion of the case members and a convex portion of the cover plate to each other to form a refrigerant flow path, in which,
in molding each of the case members by die-casting aluminum alloy,
   a portion to be welded to the cover plate and a portion along the mating surface of the case member are formed to be thick portions, and
   molding is performed such that heights of the thick portions are same over an entire surface of the case member.

According to (4), since a welding surface is flat, stable welding quality may be implemented. Further, stable welding quality may be implemented even for variations in a combination of case members molded by casting molds. Further, a plate thickness of the case members at the concave portions excluding the thick portions is reduced, whereby a weight of the battery pack may be reduced.

(5) The method for manufacturing a battery case according to (4), in which,
in welding the case members, the thick portions along the mating surfaces are welded by friction stir welding, and,
in covering the case with the cover plate, welding is performed by the friction stir welding along the convex portion of the case member and the convex portion of the cover plate.

According to (5), since only a flat portion is welded, by applying the friction stir welding, an amount of heat input is smaller than that of laser welding, and therefore a distortion of a welded product may be reduced. Accordingly, it is possible to both improve the welding quality and accuracy of a product.

What is claimed is:

1. A battery case comprising:
a refrigerant flow path formed by welding case members on which irregularities are formed to each other at mating surfaces facing each other and by covering the irregularities with a cover plate, wherein
the refrigerant flow path is formed in a direction orthogonal to a plane including the mating surfaces at a position of the mating surfaces,
each of the case members includes
a first convex portion that extends continuously and flatly without a step along a flow direction of the refrigerant flow path,
a second convex portion that extends continuously and flatly without a step in a direction orthogonal to the flow direction at a position of the mating surfaces, and
a concave portion,
the first convex portion and the second convex portion intersect with each other flatly without a step at an intersecting position,
the cover plate includes a concave portion and a convex portion extending flatly without a step along the flow direction, and
the refrigerant flow path is formed by welding the first convex portions and the convex portion of the cover plate, and includes
a first space formed between the concave portions of the case members and the concave portion of the cover plate, and
a second space formed between the second convex portions and the concave portion of the cover plate.

2. The battery case according to claim 1, wherein
the cover plate is a press-molded product made of a plate material,
the case members are die-cast products, and
the second convex portion is formed to be thicker than the concave portion of the case members.

3. The battery case according to claim 2, wherein
a height of the second space is smaller than a height of the first space in the refrigerant flow path.

4. A method for manufacturing a battery case, the method comprising:
pressing a metal plate material to form a cover plate on which an irregularity serving as a flow path is provided;
molding case members on which an irregularity is formed;
welding the case members to each other at mating surfaces to form a case; and
covering the case with the cover plate on which the irregularity is formed, and welding a convex portion of the case members and a convex portion of the cover plate to each other to form a refrigerant flow path, wherein,
in molding each of the case members by die-casting aluminum alloy,
a portion to be welded to the cover plate and a portion along the mating surface of the case member are formed to be thick portions, and
molding is performed such that heights of the thick portions are same over an entire surface of the case member.

5. The method for manufacturing a battery case according to claim 4, wherein,
in welding the case members, the thick portions along the mating surfaces are welded by friction stir welding, and,
in covering the case with the cover plate, welding is performed by the friction stir welding along the convex portion of the case member and the convex portion of the cover plate.
